(19) United States
(12) Patent Application Publication
(10) Pub. No.: US 2009/0293289 A1
(43) Pub. Date: Dec. 3, 2009

(54) Knife having superior functionality and appeal

(75) Inventors: William A. Gallop, Westminster, MA (US); Michael G. Evans, Cincinnati, OH (US); Ashish K. Mithal, North Chelmsford, MA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Waddington North America, Inc., Chelmsford, MA (US)

(21) Appl. No.: 12/455,322

(22) Filed: Jun. 1, 2009

Related U.S. Application Data
(60) Provisional application No. 61/130,684, filed on Jun. 2, 2008.

(51) Int. Cl. B26B 27/00

(52) U.S. Cl. 30/298.4

(57) ABSTRACT

A plastic knife adapted for resting on a table surface with the blade disposed in a vertical orientation. The knife includes a blade connected to a handle, a top wall, a middle wall and a bottom wall. The middle wall is connected to the blade and is orthogonal to the top and bottom walls. The blade includes a narrow blade tip and a cutting edge. The top wall features a tapering profile with a wide handle end, a narrow blade end, and a transition area of intermediate widths. The transition area is disposed between the wide handle end and the narrow blade end. The bottom wall includes a flat section for resting on a flat table surface. The knife features superior functionality and strength and may include a thin metallic coating deposited on at least a portion of one of its surfaces.

### CROSS REFERENCE TO RELATED APPLICATIONS

This application claims the benefit of the filing date of U.S. Provisional Patent Application No. 61/130,684 filed Jun. 2, 2008, the disclosure of which is hereby incorporated herein by reference.

### FIELD OF THE INVENTION

This invention relates generally to cutlery articles and in particular to a knife having a novel construction that is functionally superior to traditional disposable cutlery knives and bridges the performance and/or perception gap between disposable flatware and permanent flatware.

### BACKGROUND OF THE INVENTION

Disposable cutlery articles are well known and are ubiquitously employed in all food related industries and establishments including restaurants, cafeterias, and households—for handling, serving and consuming food. Despite their widespread use, reasonably low cost, and the convenience they provide—disposable food-service articles generally suffer from a poor-quality image perception compared to their permanent-ware counterparts. Permanent-ware articles are generally regarded as having a superior image and more suitable for an upscale presentation compared to disposable food-service articles.

One way of enhancing the appeal of disposable food-service articles is by metallizing cutlery and tableware articles. Metallized cutlery and tableware articles are described in U.S. Pat. No. 6,983,542 (Pat. '542) and US Patent Publication 2006/0191145 (Pub. '145) both of which are assigned to assignee of the current invention and are incorporated by reference herein for all purposes. These publications inter alia describe metallized plastic cutlery that offers the appearance of genuine stainless flatware. Metallized cutlery articles were commercialized in 2003 and are currently being sold by Waddington North America, Inc. (WNA). The metallized articles according to these patent publications (Pat. '542 and Pub. '145) introduce a class of food-service articles that bridge the perception gap between disposable food-service items and their permanent ware counterparts and offer significant appeal and value to caterers and other food-service establishments for upscale settings and events.

However, it will be readily appreciated by those of ordinary skill that while metallizing a plastic article can be effective in bridging the perception gap between disposable cutlery articles and permanent flatware, oftentimes the cutlery has to be made significantly heavier in order to also offer an impression of adequate strength and functionality for cutting and handling certain tough-to-cut food items such as beef and other meat preparations.

While commercially available plastic cutlery appears adequate for many occasions it does fail from time to time when used against certain types of foods. In order to achieve improved performance, the food-service industry has responded by creating heavier and heavier cutlery designs to overcome the inherent strength limitations of plastic cutlery. For example while general plastic cutlery weighs about 6 grams; certain plastic knife designs having a weight exceeding 10 grams are currently being sold in the marketplace. It will be readily recognized that heavier plastic cutlery items will naturally have higher material costs due to increased weight. In addition to the naturally higher material costs due to increased weight, it is found that a heavier cutlery piece also suffers from higher processing and molding costs. The primary reason for this is that increased knife weight also requires an increase in the cross-sectional thickness of the knife which in turn leads to slower molding cycles and thereby impacts the economics of the manufacturing process significantly. Due to these factors, at higher weights the cutlery items become either uneconomical for disposable use or receive very limited commercial acceptance.

Another drawback of disposable plastic knife constructions, most prevalent in the marketplace today, is that they require the user to typically apply considerable downwardly pressure on the knife in order to cut some difficult-to-cut foods which in turn causes the knife blade to flex and buckle or at worse break during use.

Commercial disposable plastic cutlery is generally constructed of either polystyrene or polypropylene. Polystyrene knife designs tend to break when subjected to excessive cutting force that is typically required when handling certain tough-to-cut foods such as beef. On the other hand, polypropylene knife designs are more pliable and do not break but tend to either buckle or bend sideways while cutting tough meat products. It is worth noting that typically the knife is subjected to most stress during eating compared to other cutlery articles.

Thus, there exists a need to improve the strength and performance of disposable knife articles without significantly increasing their weight. An additional motivation for reducing the weight of plastic knife articles is the long-term trend of increasing prices for petroleum-based resins that are typically used for manufacturing disposable cutlery articles. Furthermore, a number of sustainability conscious retailers including Wal-Mart® desire more environmentally friendly products which utilize less natural resources without compromising performance. A confluence of these factors, a fortiori reinforces the need for attaining a plastic knife with improved functionality and a higher performance/weight ratio. These and other needs are met by the article of the present invention.

### SUMMARY OF THE INVENTION

A feature of the invention is to bridge or at least reduce the performance gap between disposable knife articles and their permanent ware counterparts.

Another feature of the present invention is to bridge and/or reduce the performance and perception gap between disposable knife articles and permanent flatware.

One of the features of the present invention is to provide a disposable knife article that has an ergonomic handle which is comfortable to hold during use while handling and cutting food.

Another feature of the present invention is to provide a disposable knife article that can be placed on a resting surface such as a table with the blade disposed in a plane that is generally orthogonal relative to the plane of the resting surface, with one or more knife serrations touching the resting surface. For most practical purposes, the resting surface would be a generally horizontal planar top of a dining table and the knife would be positioned on the table with the blade in a vertical orientation.

Another feature of the present invention is to provide a disposable knife article that is stronger than and functionally superior to conventional disposable knife designs being sold in the marketplace.

According to an embodiment of the invention, the disposable knife article features a higher bending-rigidity-to-weight ratio compared to conventional disposable knife designs that are being currently sold in the marketplace.

Another feature of the present invention is to provide a disposable knife article that can be readily molded and produced by injection molding.

Another feature of the present invention is to provide a disposable knife article that is adapted for handling and cutting tough-to-cut food products such as beef and other meat products.

One of the features of the invention is to provide a high strength disposable knife fabricated mainly from plastic materials and having a metallic surface appearance that emulates a permanent flatware metal article.

Still other objects and advantages of the present invention will become readily apparent to those skilled in this art from the following detailed description, wherein we have shown and described exemplary embodiments of the invention contemplated by us for carrying out our invention simply by way of illustration.

### BRIEF DESCRIPTION OF THE DRAWINGS

The present invention will be readily understood by the following detailed description in conjunction with the accompanying drawings, wherein like reference numerals designate like structural elements, and in which:

FIG. 1 shows a top view of a knife that has been constructed in accordance with an embodiment of the invention.

FIG. 2 is a side profile view of the knife shown in FIG. 1.

FIG. 3 is a bottom view of the knife shown in FIG. 1.

FIG. 4 is a first isometric view of the knife shown in FIG. 1.

FIG. 5 is a second isometric view of the knife shown in FIG. 1.

FIG. 6 is a cross-sectional view of the knife shown in FIG. 1.

FIG. 7 is top view of a knife that has been constructed in accordance with another exemplary embodiment of the invention.

FIG. 8 is a side profile view of the knife shown in FIG. 7.

FIG. 9 is a bottom view of the knife shown in FIG. 7.

FIG. 10 is an isometric view of the knife shown in FIG. 7.

FIG. 11 is a top view of a knife that has been constructed in accordance with yet another exemplary embodiment of the invention.

FIG. 12 is a side view of the knife shown in FIG. 11.

FIG. 13 is an isometric view of the knife shown in FIG. 11.

FIG. 14 is a side view of the knife that has been constructed in accordance with another exemplary embodiment of the invention.

### DETAILED DESCRIPTION OF THE INVENTION

The following description of the exemplary embodiments of the invention along with accompanying figures has been presented by way of illustration and to facilitate an understanding of the invention by one of ordinary skill. It is neither meant to be exhaustive nor intended to limit the scope of the invention in any way; and, accordingly many modifications and variations are possible in the light of the disclosure. Furthermore, the features and advantages described herein are not all-inclusive and, in particular, many additional features and advantages will be apparent to one of ordinary skill in the art in view of the drawings, specification, and examples of claims. As will also be realized, the invention is capable of other and different embodiments, and its several details are capable of modifications in various respects without departing from the spirit and scope of the invention.

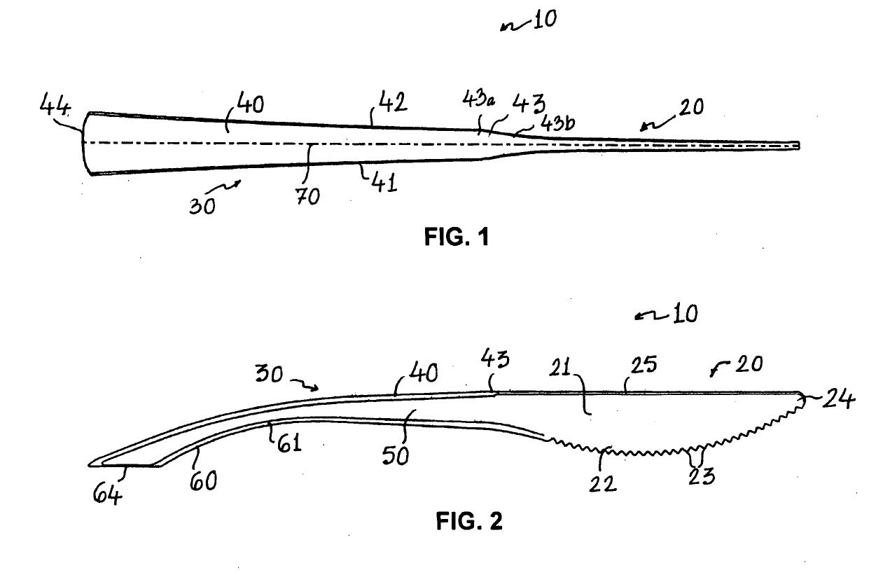

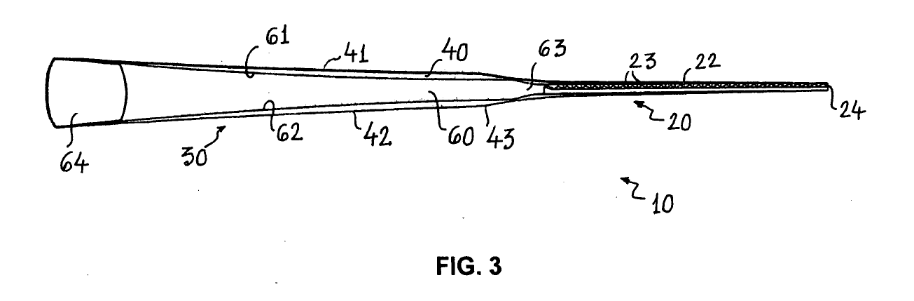

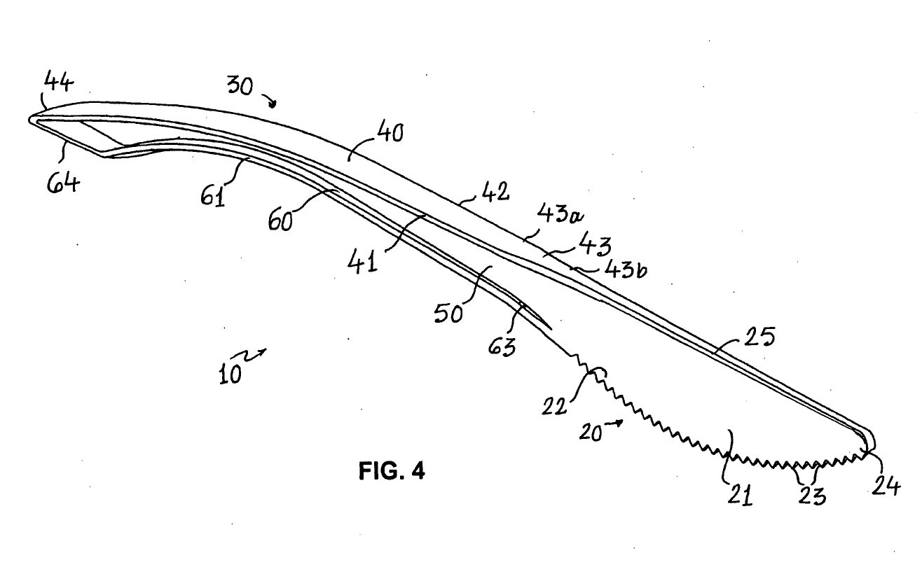

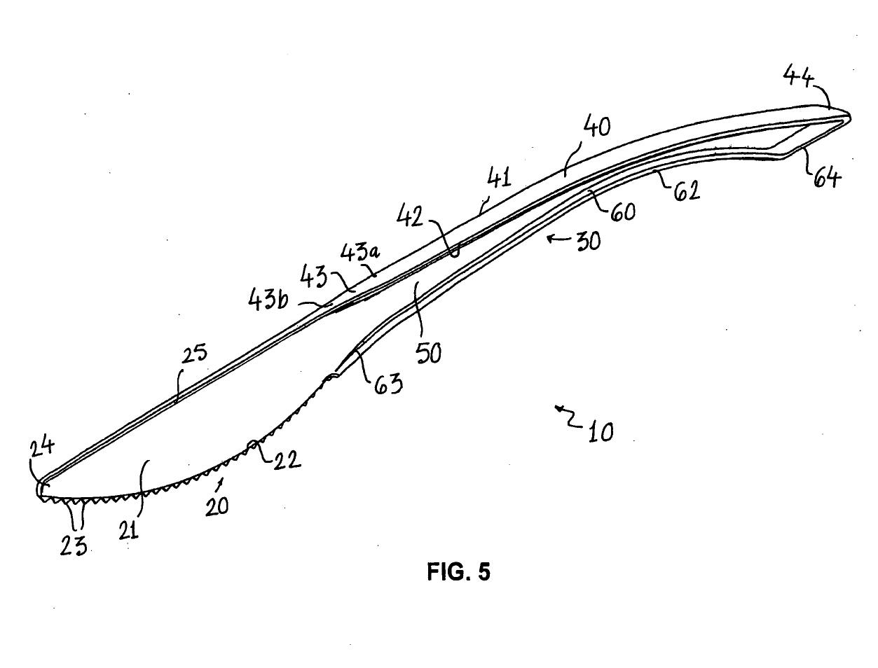

Referring to FIGS. 1 through 6 there is shown knife 10 constructed in accordance with an embodiment of the present invention wherein like parts bear like reference numerals, however not all features or parts are identified by reference numerals; also, the parts that have designated reference numerals are not necessarily shown or identified in all views.

The knife 10 according to the present invention can be positioned on the table with the knife blade in a vertical orientation as best shown in FIG. 2, with the blade serrations pointing downwardly towards the table surface. In contrast conventional disposable knife constructions generally sit flat on the table in a lateral or sideways position. It will be of course realized that the knife according to the present invention can also be placed on the table in the conventional manner if so desired by the user.

Knife 10 comprises a blade portion 20 and a handle portion 30. In the exemplary embodiment described here, knife 10 is symmetrical about the longitudinal axis 70 as shown in FIG. 1. It will be realized by those of ordinary skill that symmetry about the longitudinal axis is not an essential requirement for accomplishing the objects of the present invention.

Blade portion 20 comprises blade 21. Blade 21 features a bottom cutting edge 22 having a plurality of serrations or teeth 23 and a narrow blade tip 24. Bottom edge 22 is arcuate and teeth 23 are adapted for cutting a variety of food items. Blade 21 also features a top rib 25 adapted for stiffening the blade 21.

It would be recognized by those of ordinary skill that the bottom cutting edge 22 and teeth 23 can be specifically adapted for cutting tough-to-cut foods; and, that the cutting edge and the serrations can be readily modified to optimize cutting performance in accordance with the end-use application and the material of construction of knife 10.

Knife 10 also comprises a top wall 40 which extends from the handle portion 30 to the blade portion 20. The top wall 40 has a pair of side edges 41 and 42 that extend along the length of top wall 40. The top wall 40 features a blade-to-handle transition region or top transition area 43 that is disposed in an intermediate relationship to the handle and blade sections of the top wall 40. Top transition area 43 is also suitably positioned relative to the blade and handle portions 20 and 30 respectively, for allowing a user to comfortably to place his/her finger(s) in the general vicinity thereof while using knife 10 in a functional manner. Top transition area 43 can have a tapering profile as best shown in FIGS. 1, 4 and 5. The wider end of top transition area 43 is denoted by 43a while the narrow end of top transition area 43 is denoted by 43b. The wider end 43a of top transition area 43 is disposed adjacent to the handle section of top wall 40. The narrow end 43b of top transition area 43 is disposed adjacent to the blade section of top wall 40 wherein the side edges 41 and 42 of top wall 40 narrow into and meet with top rib 25 disposed at the top end of blade 21.

At end 44 distal to the blade portion 20, the top wall 40 is shown as having a flared configuration. As best shown in FIG. 2, at end 44 distal to blade portion 20, top wall 40 curves downwardly towards the table surface in a generally arcuate fashion.

It will be recognized by those of ordinary skill that the width of the top wall or the distance between side edges 41 and 42 is readily adaptable in accordance with the desired physical size and shape attributes of the knife. According to a specific embodiment of the invention the width of the top wall (or the distance between the side edges 41 and 42) about the handle section of the top transition area 43 at its wider end 43a is greater than 0.25″. According to still another embodiment of the invention the width of the top wall about the handle section of the top transition area 43 at its wider end 43a is greater than 0.30″.

Knife 10 or particularly the handle portion 30 also comprises a mid wall 50, and a bottom wall 60.

The bottom wall 60 is of an ergonomic shape for comfortably holding the knife and preferably features a concave shape, i.e., is curved away from the table surface to allow the user to grasp the knife by inserting his/her fingertips underneath the bottom wall 60. The bottom wall 60 has a pair of side edges 61 and 62 that extend along the length of the bottom wall 60. The bottom wall 60 features a bottom transition area 63 proximal to the blade portion 20. In the bottom transition area 63, side edges 61 and 62 narrow into and meet with blade 21. At the end distal to the blade portion 20, the bottom wall 60 features a flat section 64. Flat section 64 is substantially planar and is adapted for resting against a table or other surface.

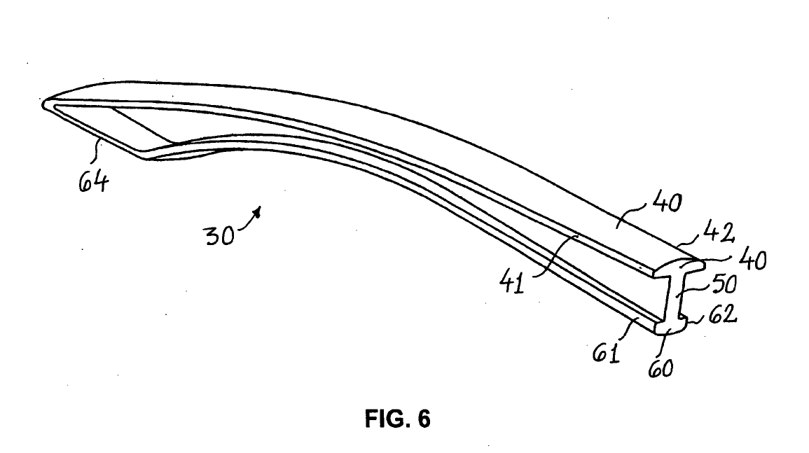

The mid wall 50 is substantially coplanar and longitudinally continuous with the blade 21. As best shown in cross-sectional view of the handle portion 30 in FIG. 6 the top wall 40 and the bottom wall 60 project transversely on either side of the mid wall 50 in a generally orthogonal relationship thereto so as to generally form a cross section with the configuration of an I. According to the exemplary embodiment shown in FIGS. 1 through 6, the bottom wall 60 is depicted as being narrower than top wall 40 for most of its length. It will be appreciated by those skilled in the art that a narrower bottom wall 60 provides an opportunity for reducing the weight of the knife while still allowing the top wall 40 to be functionally wide enough for obtaining improved knife performance and allowing a user to comfortably hold the knife handle and press on or about top transition area 43 for cutting and manipulating food items. However, it will be realized by those of ordinary skill that the invention is not limited to the as-shown relative difference between the width of top and bottom walls; accordingly, the width of the bottom wall can be—less than, or equal to, or greater than—the width of the top wall.

Knives according to the present invention may be configured to a variety of sizes and weights. For example, according to an embodiment of the invention the overall length and weight of such knives may generally range from 5 to 9 inches long, and 3 to 9 grams in weight. According to certain embodiments of the invention a knife may be longer than 7.5 inches in length and weigh less than 7.5 grams; longer than 7.5 inches in length and weigh less than 7 grams; longer than 7.5 inches in length and weigh less than 6.5 grams; longer than 7 inches in length and weigh less than 6 grams; longer than 7 inches in length and weigh less than 5.5 grams; or longer than 7 inches in length and weigh less than 5 grams.

It would be clear to those skilled in the art that a variety of thermoplastic polymer types and/or resin grades can be employed for the purpose of making the food-service articles of the present invention. Material choices for such applications are governed by a variety of factors including consumer preferences, cost, engineering requirements, availability and other economic and market factors. Accordingly plastic resins including polypropylene (PP), polystyrene (PS), polycarbonate (PC), styrene-acrylonitrile (SAN), or derivatives and blends thereof can be utilized for making the articles of the present invention. In addition, the knife can be constructed from bio-resins or incorporate biodegradable materials such as polylactic acid (PLA) or polyhydroxyalkanoate (PHA). In addition, the knife may include a variety of colorants, degradation enhancing additives, processing aids, fillers or other additives. The plastic knife may have an optical density in the range of 0.5 to 6, with preferred optical densities of less than 6, less than 3, and greater than 0.5. Examples of such densities include 0.5 to 3 and 0.5 to 6.

Knives constructed of such materials may have specific gravities between 0.5 and 1.5. Preferred embodiments of knives may have a specific gravity of greater than 1, be longer than 7.5 inches in length, and weigh less than 7.5 grams; a specific gravity of less than 1, be longer than 7.5 inches in length, and weigh less than 6.5 grams; a specific gravity of greater than 1, be longer than 7 inches in length, and weigh less than 6 grams; or a specific gravity less than 1, be longer than 7 inches in length, and weigh less than 5.5 grams.

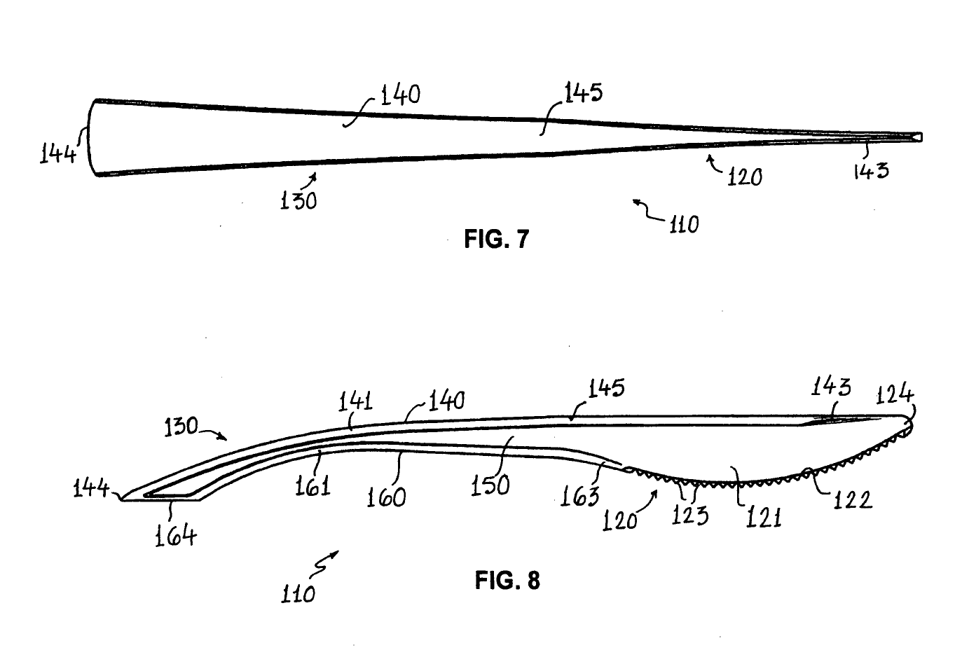

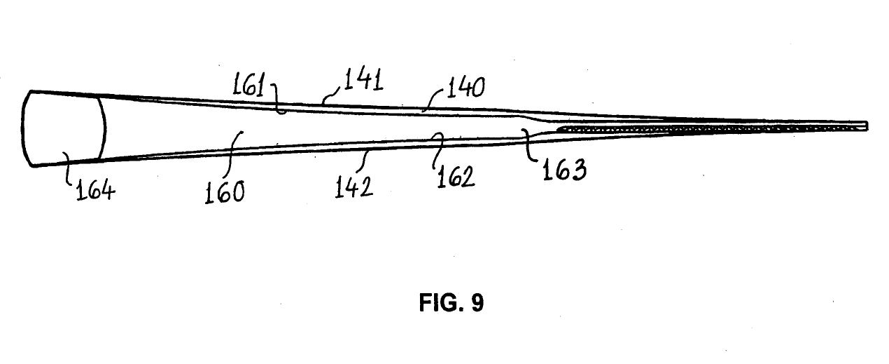

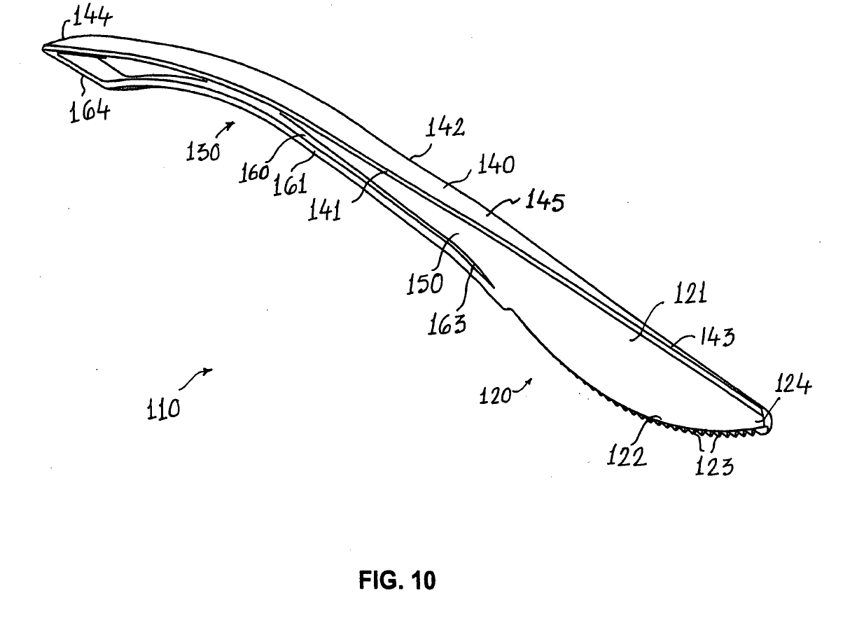

Another exemplary embodiment of the invention showing knife 110 is depicted in FIGS. 7 through 10 wherein, as before, like parts bear like reference numerals. Knife 110 includes a blade portion 120 and a handle portion 130. Blade portion 120 comprises blade 121. Blade 121 features a bottom cutting edge 122 having a plurality of serrations or teeth 123 and a narrow blade tip 124. Bottom edge 122 is arcuate and teeth 123 are adapted for cutting a variety of food items. As best shown in FIG. 8, knife 110 is adapted to be positioned on a generally horizontal surface such as a table, wherein blade 121 is generally vertical.

Knife 110 includes a top wall 140, which extends from the handle portion 130 to the blade portion 120. The top wall 140 has a pair of side edges 141 and 142 that extend along the length of the top wall 140. The top wall 140 features a tapering profile having a flared end 144 distal to the blade tip 124, a narrow end 143 proximate to the blade tip 124, and a transition area 145 of intermediate width located between the flared end 144 and narrow end 143. At the narrow end 143, the side edges 141 and 142 of top wall 140 taper into and blend with blade 121. At end 144 distal to the blade portion 120, the top wall 140 is shown as having a generally arcuate shape and curves downwardly towards the table surface. It will be recognized by those of ordinary skill that the width of the top wall or the distance between side edges 41 and 42 is readily adaptable in accordance with desired physical size and shape attributes of the knife as discussed above.

The handle portion 130 of knife 110 also includes a mid wall 150 and a bottom wall 160.

The bottom wall 160 is preferably of an ergonomic and concavely arcuate shape, and similar in construction to the bottom wall 60 described above in conjunction with FIGS. 1 through 6. The bottom wall 160 has a pair of side edges 161 and 162 that extend along the length of the bottom wall 160. The bottom wall 160 features a bottom transition area 163 proximal to the blade portion 120 where the side edges 161 and 162 narrow into and meet with blade 121. At the end distal to the blade portion 120 the bottom wall 160 includes a flat area 164. Flat area 164 is adapted for resting against a generally horizontal surface such as a table.

The mid wall 150 is substantially coplanar and longitudinally continuous with the blade 121. As described in the previous embodiment of the invention described in connection with FIGS. 1 through 6, the top wall 140 and the bottom wall 160 may project transversely on either side of the mid wall 150 in a generally orthogonal relationship thereto so as to generally form a cross section with the configuration of an I. It would be realized by one of ordinary skill that top wall 140 and bottom wall 160 may project transversely from mid wall 150 in a symmetric or asymmetric fashion.

It will be readily understood by those skilled in the art that the knife construction described hereinabove and shown in accompanying figures can be implemented in a variety of shape configurations, blade-to-handle ratios and sizes. The physical configurations and design features and aspect ratios exhibited here are done for the purpose of illustration and not by way of limitation. Furthermore, the knife of the present invention can be readily adapted to include various patterns and ornamental features or other adornments known in the art.

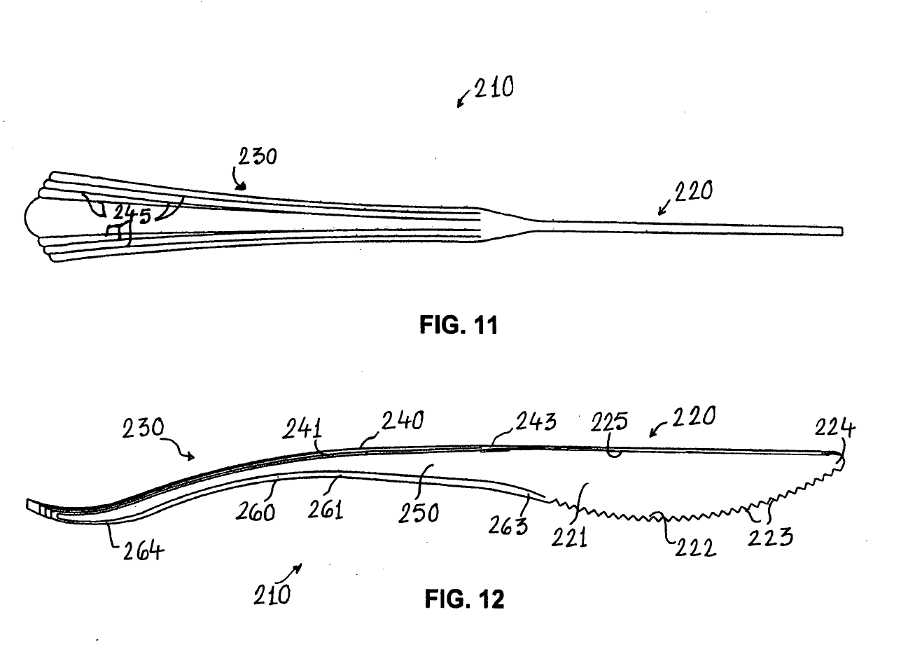

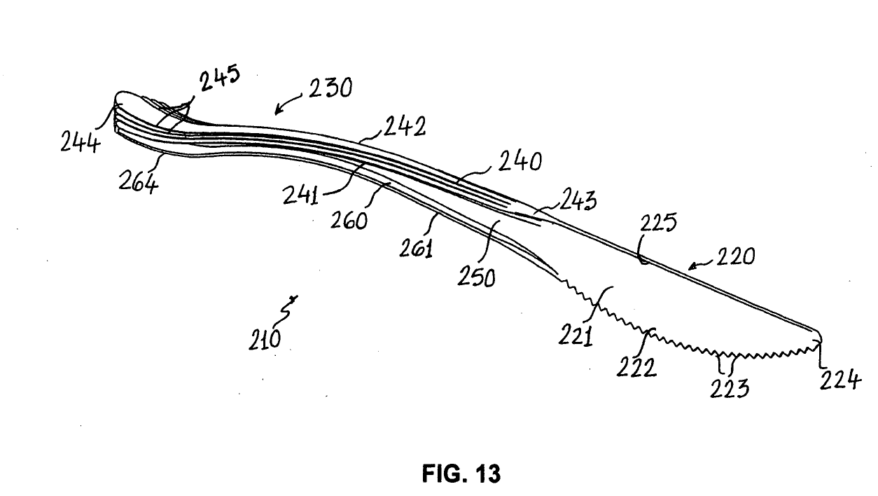

Referring now to FIGS. 11 through 13, there is shown knife 210, constructed in accordance with an exemplary embodiment of the present invention wherein the knife top wall features an ornamental design. Knife 210 comprises a blade portion 220 and a handle portion 230.

The blade portion 220 comprises blade 221. Blade 221 features a bottom cutting edge 222 having a plurality of serrations or teeth 223 and a narrow blade tip 224. Blade 221 also features a top rib 225 adapted for imparting additional strength and stiffness to blade 221.

Knife 210 also comprises a top wall 240 which extends from the handle portion 230 to the blade portion 220. The top wall 240 has a pair of side edges 241 and 242 that extend along the length of top wall 240. Top wall 240 features top transition area 243 that is intermediately disposed between the handle portion 230 and the blade portion 220 of knife 210. Top wall 240 also displays a plurality of surface features or patterns generically denoted by reference numeral 245. It will be readily appreciated by those of ordinary skill that the pattern or geometric features shown in this embodiment are exemplary and a variety of designs and design features can be placed on the top wall 240 or generally in the handle portions of any of the knives shown in any one of the accompanying figures.

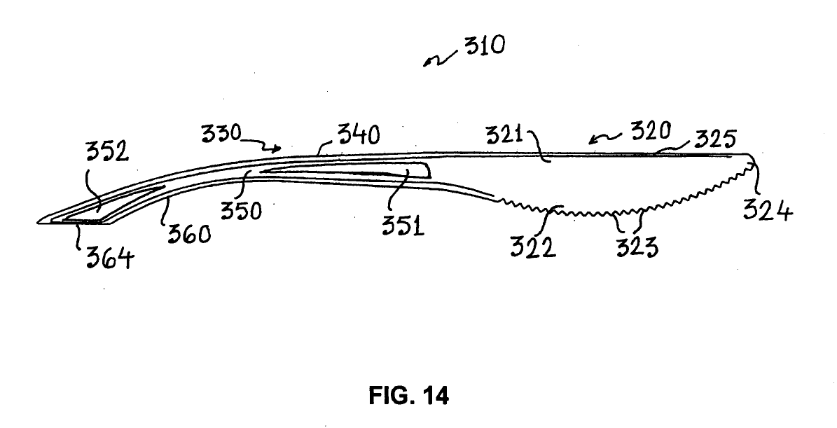

FIG. 14 shows yet another embodiment of the invention, in the form of knife 310 which is similar in construction to knife 10 shown in FIGS. 1 through 6, with the exception of—presence of one or more opening or holes that are provided for further decreasing part weight. In FIG. 14, knife 310 comprises openings 351 and 352. In alternate embodiments, knife 310 can be constructed with just one opening. In a preferred embodiment of the invention knife 310 features one opening 352 proximal to flat area 364.

One of the features of the instant invention inter alia was to provide a knife article that, either in whole or in part, is characterized by having a metallic coating and emulating a permanent flatware article. Disposable cutlery and tableware articles that emulate permanent flatware are described in U.S. Pat. No. 6,983,542 ('542) and U.S. Pat. Pub. 2006/0191145 ('145) the disclosures of which are incorporated herein by reference for all purposes. Accordingly, the metallic coating may be of a thickness between 50 and 1,000 nanometers, with preferred thicknesses of less than 1000 nanometers, less than 500 nanometers, less than 200 nanometers, and less than 100 nanometers.

Accordingly, in an embodiment of the invention, at least one of the knife constructions showed in FIGS. 1 through 14, (10, 110, 210 and 310) comprises a metallic coating on the exterior surfaces thereof. According to another embodiment of the invention the knife comprises a metallic coating on only a portion thereof. According to yet another embodiment of the invention the knife features a metallic coating on the top wall. According to still another embodiment of the invention the knife is coated with a stainless steel coating. According to still another embodiment of the invention the knife emulates gold or golden permanent flatware. According to another embodiment of the invention the metallic coating is Titanium Nitride. According to still another embodiment of the invention, at least portions of the knife, including metallic covered portions, may be coated with a non-metallic coating such as water based polymeric overcoating. The non-metallic coating may protect the metallic coating and may enhance the durability thereof, if so provided.

Although, this invention has been described particularly in relation to the knife, it will be recognized that the features and benefits of the handle construction described herein are applicable to other articles including tableware articles that feature a handle portion including spoons, forks, tongs, spatulas, cake cutters and the like. Also, it would be realized by those skilled in the art that various modifications, alterations and adaptations can be made to this invention without departing from the spirit and scope of this invention.

Numerous characteristics and advantages have been set forth in the foregoing description, together with details of structures and functions of the present invention, and some of the novel features thereof are pointed out in appended examples of claims. The foregoing description and disclosure, however, is illustrative only, and change may be made in arrangement and details, within the principle of the invention to the full extent indicated by the broad general meaning of the terms in which the appended examples of claims are expressed.

We claim:

1. A plastic knife article comprising:
a handle, a blade connected to said handle, said blade comprising a narrow blade tip and a cutting edge;
a top wall, a middle wall and a bottom wall;
wherein said middle wall is connected to said blade and is disposed in an orthogonal relationship to said top and bottom walls;
said top wall comprising a generally tapering profile with a wide handle end, a narrow blade end, and a top transition area of intermediate width; wherein said wide handle end is located distal to said narrow blade tip, said narrow blade end being located proximal to said narrow blade tip, and said top transition area being disposed between said wide handle end and said narrow blade end;
said bottom wall including a generally flat portion adapted for placement on a generally horizontal surface, where said blade can rest in a generally vertical orientation.

2. The plastic knife article according to claim 1, wherein said bottom wall is arcuate in shape.

3. The plastic knife article according to claim 1, wherein said top wall is arcuate in shape.

4. The plastic knife article according to claim 1, wherein said generally flat portion of said bottom wall portion is disposed at an end distal to said narrow blade tip, said generally flat portion being adapted for contacting said generally horizontal surface.

5. The plastic knife article according to claim 1, further comprising a thin metallic coating deposited by a vapor deposition process on at least a portion of one of the surfaces of said knife article, and wherein said thin metallic coating is less than 1000 nanometers in thickness.

6. The plastic knife article according to claim 5, further comprising a non-metallic coating over said thin metallic coating.

7. The plastic knife article according to claim 1, further comprising a thin metallic coating of a stainless steel alloy deposited by a vapor deposition process on at least a portion of one of the surfaces of said knife article, and wherein said thin metallic coating is less than 1000 nanometers in thickness.

8. The plastic knife article according to claim 1, further The plastic knife article according to claim 1, further comprising a thin metallic coating of a steel alloy deposited by a vapor deposition process on at least a portion of one of the surfaces of said knife article, and wherein said thin metallic coating is less than 1000 nanometers in thickness.

9. The plastic knife article according to claim 1, further comprising a thin metallic coating of titanium nitride deposited by a vapor deposition process on at least a portion of one of the surfaces of said knife article, and wherein said thin metallic coating is less than 1000 nanometers in thickness.

10. The plastic knife article according to claim 1, further comprising a thin metallic coating deposited by a vapor deposition process, and wherein said thin metallic coating is less than 500 nanometers in thickness.

11. The plastic knife article according to claim 1, further comprising a thin metallic coating deposited by a vapor deposition process and wherein said thin metallic coating is less than 200 nanometers in thickness.

12. The plastic knife article according to claim 1, further comprising a thin metallic coating deposited by a vapor deposition process and wherein said thin metallic coating is less than 100 nanometers in thickness.

13. The plastic knife article according to claim 1, wherein said plastic knife article is at least partially composed of polystyrene.

14. The plastic knife article according to claim 1, wherein at least a portion of said plastic knife article has an optical density of less than 6.

15. The plastic knife article according to claim 1, wherein at least a portion of said plastic knife article has an optical density of less than 3.

16. The plastic knife article according to claim 1, wherein at least a portion of said plastic knife article has an optical density of greater than 0.5.

17. The plastic knife article according to claim 1, wherein said plastic knife article is produced by injection molding.

18. The plastic knife article according to claim 1, wherein said plastic knife article is at least partially composed of polypropylene resin.

19. The plastic knife article according to claim 1, wherein said plastic knife article is constructed from a resin that is compostable.

20. The plastic knife article according to claim 1, wherein said plastic knife article is biodegradable.

21. The plastic knife article according to claim 1, wherein said plastic knife article comprises a biodegradable additive.

22. The plastic knife article according to claim 1, wherein said plastic knife article is longer than 7.5 inches in length, and weighs less than 7.5 grams.

23. The plastic knife article according to claim 1, wherein said plastic knife article is longer than 7 inches in length, and weighs less than 6.5 grams.

24. The plastic knife article according to claim 1, wherein said plastic knife article is longer than 7 inches in length, and weighs less than 6 grams.

25. The knife of claim 1, wherein said middle wall includes at least one aperture.

26. The knife of claim 1, wherein said handle has a cross section in the shape of an I.

27. A plastic knife comprising:
a handle having a top wall and a bottom wall configured about a mid wall, said top and bottom walls being perpendicular to said mid wall;
a blade extending from said mid wall, said blade including a cutting surface adjacent said bottom wall and an upper surface forming a continuation of said top wall;
said handle further comprising a base area adjacent said bottom wall;
wherein, said knife is adapted to rest on a generally flat surface such that said base area and at least a portion of said cutting surface abut the generally flat surface and support said knife in such orientation.

28. The knife of claim 27, wherein said base area is generally flat.
